(19) United States
(12) Patent Application Publication
(10) Pub. No.: US 2015/0041696 A1
(43) Pub. Date: Feb. 12, 2015

(54) VALVE DRIVE FOR ACTUATING A VALVE

(71) Applicants: Mikhail Evgenievich Fedosovsky, Saint-Petersburg (RU); Vyacheslav Viktorovich Nikolaev, Saint-Petersburg (RU); Vadim Igorevich Dunaev, Saint-Petersburg (RU)

(72) Inventors: Mikhail Evgenievich Fedosovsky, Saint-Petersburg (RU); Vyacheslav Viktorovich Nikolaev, Saint-Petersburg (RU); Vadim Igorevich Dunaev, Saint-Petersburg (RU)

(21) Appl. No.: 14/522,309

(22) Filed: Oct. 23, 2014

Related U.S. Application Data
(63) Continuation-in-part of application No. PCT/RU2013/000347, filed on Apr. 23, 2013.

(30) Foreign Application Priority Data
Apr. 23, 2012 (RU) 2012116034

(51) Int. Cl. F16K 31/53; F16K 31/50

(52) U.S. Cl. CPC F16K 31/535; F16K 31/504
USPC 251/249.5; 251/250

(57) ABSTRACT

A valve drive for actuating a valve comprises a main motor, a main shaft, a transmitting device comprising a nut and a spindle and adapted to transform rotational movement of the nut into a translational movement of the spindle, and driving means adapted to move the spindle, wherein the main motor is adapted to transfer rotation to the nut via the main shaft, and the spindle is adapted to open and close the valve during the translational movement of the spindle. The valve drive for actuating a valve further comprises a differential mechanism mounted between the main motor and the main shaft, said differential mechanism comprising a first input shaft connecting the differential mechanism to the main motor, and a second input shaft. The output shaft of the differential mechanism is the main shaft.

### RELATED APPLICATIONS

This application is a continuation-in-part of International application PCT/RU2013/000347 filed on Apr. 23, 2013 which claims priority benefits to Russian patent application RU 2012116034 filed on Apr. 23, 2012. Each of these applications is incorporated herein by reference for all purposes.

### FIELD OF THE INVENTION

The invention relates to means for actuating a valve, in particular to a drive for actuating a valve. The present valve-drive for actuating a valve can be used particularly in the field of power engineering for turbine control systems as a drive for actuating a steam-distributing valve of steam turbines.

### BACKGROUND ART

Conventional turbine control systems are often implemented with hydraulic control. Such systems comprise large hydraulic cylinders actuating steam-distributing valves. Further, such systems comprise spool-type hydraulic systems for actuating the hydraulic cylinders. In some cases, the hydraulic cylinders can be actuated electrohydraulically through the spool, but unlike the above example, in this case, the spool is actuated by means of electromechanical drives.

Systems of this type always contain a power fluid, e.g. power oil in volumes constituting a fire hazard, and the use thereof requires utilizing hydraulic systems, which in turn require proper procedures and periodic maintenance to ensure operationability, which is a disadvantage of such systems.

It must also be noted that steam-distributing valve control usually requires providing substantial force, e.g. a force of several tons, as well as operation at relatively high speeds. In case of emergency or extraordinary situations, measures must be taken extremely swiftly, within several hundreds of milliseconds. Furthermore, maximum exerted force must be constant across the working stroke range. In solutions known in the art, the implementation of the above requirements led to forming complex, cumbersome hydraulic systems with large volumes of working fluids (oil) constituting a fire hazard, which ultimately decreased reliability and safety while increasing the steam turbine running costs.

The necessity to overcome the above disadvantages in hydraulic and electrohydraulic control systems leads to an object of providing a drive that possesses large pulse power, but does not comprise complex hydraulic devices and systems, which is a rather complicated engineering problem. However, said object can be alleviated by the fact that the main force is required for opening the steam-distributing valve and said force is unidirectional, while a high velocity of valve status change is required only in case of emergency closure of the valve, during which the force is applied in another direction.

U.S. Pat. No. 5,832,944, which is the closest prior art to the present invention, discloses a valve drive for actuating a valve for a steam-distributing valve, comprising a main motor, a main shaft and a transmitting device comprising a nut and a valve spindle and adapted to transform rotational movement of the nut into a translational movement of the spindle. The main motor is adapted to transfer rotation to the nut via the main shaft, and the spindle is adapted to open and close the valve during the translational movement of the spindle. Furthermore, the valve drive for actuating a valve comprises driving means formed by an energy accumulator comprising a return spring connected to the spindle and a coupling disposed between the motor and the main shaft and adapted to be disengaged from the motor. The spring is mounted in such way that it accumulates energy when the valve is being opened, and it can release said energy during closure of the valve.

The valve drive for actuating a valve of U.S. Pat. No. 5,832,944 is operated as follows: rotation of the motor is transferred via the main shaft to the nut of the transmitting device, said transmitting device transforms said rotation into the translational movement of the spindle, and in turn, the spindle moves the valve to close or open it. When the valve is being opened, the spring accumulates energy. The motor prevents the spring from returning to the original position. When it is necessary to quickly close the valve, the coupling is activated to disengage the motor from the main shaft, and the spring returns to the original position, thus ensuring a quick closure of the valve.

Even though the valve drive for actuating a valve of U.S. Pat. No. 5,832,944 does not comprise hydraulic devices and provides quick closure of the valve, said drive has several disadvantages. The disadvantages are primarily associated with the fact that the drive system utilizes only a return spring for quick and uncontrolled closing of the steam-distributing valve. It is technically difficult to implement the “rigid” transfer of the rotational torque via the coupling, which is necessary to minimize error in valve positioning. Furthermore, the drive system does not provide structural versatility when using additional elements necessary in specific embodiments, e.g. for controlling the speed of valve closure by the spring.

### SUMMARY OF THE INVENTION

The object of the present invention is to provide a valve drive for actuating a valve so as to at least alleviate the disadvantages of the prior art, particularly through use of a plurality of driving means for quick closure of the valve, wherein a particular driving means can be selected from the plurality of driving means based on particular application. This would provide structural versatility, in particular, the possibility of simply providing additional elements, e.g. for controlling speed by which the valve is closed.

Said object is achieved by a valve drive for actuating a valve comprising a main motor, a main shaft, a transmitting device comprising a nut and a spindle and adapted to transform rotational movement of the nut into a translational movement of the spindle, and driving means adapted to move the spindle, wherein the main motor is adapted to transfer rotation to the nut via the main shaft, and the spindle is adapted to open and close the valve during the translational movement of the spindle. The present drive further comprises a differential mechanism mounted between the main motor and the main shaft, said differential mechanism comprising a first input shaft connecting the differential mechanism to the main motor, and a second input shaft. The output shaft of the differential mechanism is the main shaft. The differential mechanism provides the technical result of simplifying drive control, particularly via controlling the second shaft. The drive further comprises a stop device adapted to stop the second shaft, which particularly allows to implement said second shaft control.

It must be noted that the driving means allow to move the spindle without utilizing the main motor, or the spindle can be moved along with the main motor. In particular, driving means allow quicker movement of the spindle to quickly close the valve. Furthermore, driving means can have different configurations and can possess different characteristics adapted for achieving specific goals, as discussed hereinafter in more detail.

Use of a differential mechanism allows to utilize a plurality of driving means mounted on the second output shaft. This provides high structural versatility of the drive, since a suitable driving means can be selected from the plurality according to a specific embodiment.

In one embodiment, the main motor comprises at least one servomotor. In some embodiments, two servomotors can be used. The use of a servomotor provides the highest accuracy and operation speed when controlling the position of the valve; furthermore, an additional servomotor allows to increase reliability of the drive.

In another embodiment, the drive can further comprise a rotation preventing mechanism adapted to prevent rotation of the spindle.

In the preferred embodiment, the transmitting device is formed as a roller screw, wherein the spindle has a screw thread, and transmitting thread rollers are provided between the nut and the spindle. In another embodiment, the transmitting device can be formed as a ball screw, wherein the spindle has a screw thread, and transmitting balls are provided between the nut and the spindle. The use of roller screws or ball screws provides high accuracy and reliability of the drive. Roller screws can be conventional units with a nut end play, or can be units without end play in order to increase the spindle positioning accuracy.

In one embodiment of the drive, the gear ratio between the first input shaft and the main shaft and between the second input shaft and the main shaft of the differential mechanism is represented by equation i₂=i₁/(i₁+1) or i₂=(i₁+1)/i₁, where i₁ is gear ratio between the first input shaft and the main shaft, and i₂ is gear ratio between the second input shaft and the main shaft, wherein i₁≧3. Said gear ratios are optimal with regards to mass and dimensional characteristics of the drive and provide quick closure of the valve if necessary.

In a preferred embodiment, driving means are formed by a second motor mounted on the second input shaft and adapted to transfer rotation via the differential mechanism and the main shaft to the nut in order to actuate the spindle. In this case, a more powerful second motor can be used to provide quick closure of the valve. In the most preferred embodiment, the second motor has greater nominal power than the main motor. Such embodiment is optimal in terms of energy consumption and emergency valve closure speed and provides high reliability of the drive in various extraordinary situations.

In another embodiment, the driving means are formed by a spring assembly adapted to accumulate energy when opening or closing the valve and adapted to release the accumulated energy when the stop device is released, in order to quickly close or open the valve. The spring assembly is advantageous in terms of reducing the overall size of the drive. In one preferred embodiment, the spring assembly, e.g. comprising a torsional spring, is mounted on the second input shaft and adapted to transfer rotation from said shaft via the differential mechanism and the main shaft to the nut in order to actuate the spindle. In another preferred embodiment, the transmitting device is further adapted to transform translational movement of the spindle into rotational movement of the nut. The spring assembly comprises a return spring connected to the spindle. The spindle is connected to the valve with a lever, and the spring assembly comprises a return spring connected to said lever.

If a return spring is used, the driving means preferably comprise at least one two-chamber hydraulic cylinder and a hydraulic control valve for controlling the hydraulic cylinder, wherein the rod of said at least one hydraulic cylinder is coupled to the valve, wherein the hydraulic control valve is adapted to control speed of the valve closure and/or opening. This arrangement allows to control speed of the valve closure by means of the spring assembly. Most preferably, the hydraulic control valve is adapted to restrain valve movement, particularly by closing off working fluid movement in at least one chamber of the hydraulic cylinder. This allows to stop the valve movement when the valve is in intermediate position, which can be useful for partial closure of the valve.

In one embodiment of the drive, the stop device is formed by a self-locking worm gear adapted to disengage gears thereof. Self-locking worm gears are widespread, and the use thereof is advantageous in both technical and cost-saving terms.

In the preferred embodiment, the drive is used for actuating a steam-distributing valve.

### BRIEF DESCRIPTION OF THE DRAWINGS

Further details and embodiments of the invention are described below in more detail with reference to the accompanying drawings.

FIG. 1 schematically shows the first embodiment of the invention with driving means formed by a second motor.

FIG. 2 schematically shows the second embodiment of the invention with driving means formed by a spring assembly.

### DESCRIPTION OF THE INVENTION

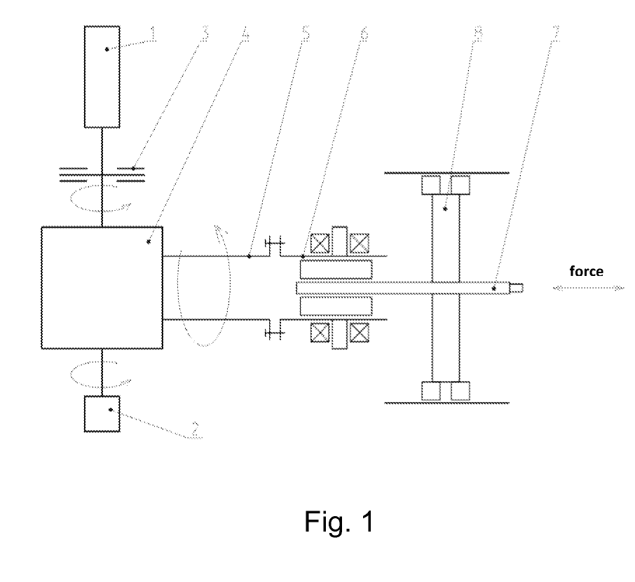

In the embodiment shown in FIG. 1, a drive for actuating a steam-distributing valve comprises a motor 1 providing rapid movement of the valve. The drive further comprises a servomotor 2 for moving the valve during normal operation. The nominal power of motor 1 is greater than the nominal power of servomotor 2. A stop device 3 connected to the output shaft of motor 1 is provided for retaining motor 1 in the “off” position. Output shafts of motors 1 and 2 are the first and second input shafts of a differential reducer 4 adapted to connect the received torques and to supply the joint torque to a main shaft 5. Gear ratios between the first and second input shafts and the main shaft 5 are not equal. Main shaft 5 is connected to a roller screw comprising a nut 6 and spindle or screw 7 connected to the steam-distributing valve. The roller screw allows to transform rotation received by the nut 6 from the main shaft 5 into translational movement of screw 7, which is transmitted to the steam-distributing valve. The drive further comprises a rotation preventing mechanism 8 to prevent barring of screw 7.

The drive is operated as follows:

(a) When performing low-speed movement, the servomotor 2 is used for moving the spindle in normal operation. The rotation of the output shaft of servomotor 2 (the first input shaft) is transmitted via the differential reducer 4 to the main shaft 5 with gear ratio e.g. 17:1. In turn, the main shaft 5 rotates nut 6, thus moving screw 7 coupled to the steam-distributing valve. Therefore, servomotor 2 performs useful work of moving the spindle and thus, opening or closing the steam-distributing valve. The utilized power in this case is relatively low due to the selected gear ratio of the reducer 4 and low movement speed, thus heat elimination issues do not occur. Furthermore, as the required power is relatively low, the required frequency converter can be relatively small, which allows for a small-sized drive control unit.

(b) When a mode of operation with high-speed movement and dynamics is required, the movement of the spindle is performed by means of motor 1. The gear ratio between motor 1 and the main shaft 5 in both cases when servomotor 2 is used, for example, during the opening or closing of the valve, or is idle, in case when the valve is closed or opened, is about 1:1. Furthermore, due to low duration of said mode, motor 1 can be used with power values exceeding nominal power for said motor. The force transfer from the main shaft 5 to the valve is similar to the transfer in normal operation.

The present drive provides the following advantages:

1. Wide dynamic speed range.

2. Compact size.

3. Low average power consumption.

4. High reliability of the drive.

5. High accuracy of movement performed by means of the drive.

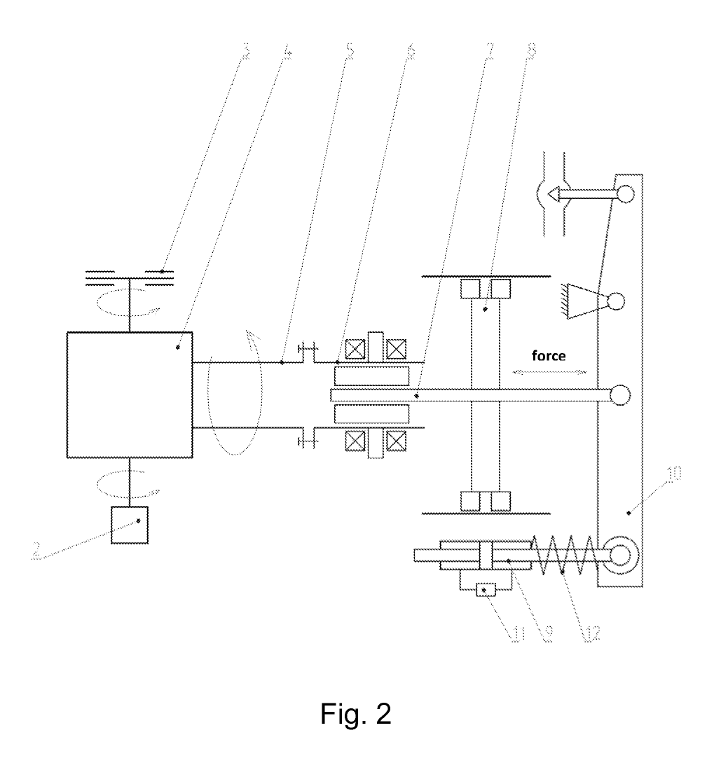

In some cases, a modified drive can be used. Said drive does not comprise motor 1 providing rapid movement. FIG. 2 shows an example of such modified drive. Unlike the embodiment shown in FIG. 1, the drive does not comprise motor 1. Therefore, the force transfer method to the steam-distributing valve is modified in such way that screw 7 actuates the steam-distributing valve via lever 10. Such arrangement allows the use of a plurality of additional driving means. In this embodiment, the plurality of driving means comprise a two-chamber hydraulic cylinder 9, a hydraulic valve 11 for controlling the hydraulic cylinder, and a spring assembly comprising a return spring 12.

The spring assembly is formed in such way that the return spring 12 accumulates energy when the steam-distributing valve is being opened. The accumulated energy can be used for closing the steam-distributing valve quickly when necessary. Hydraulic cylinder 9 and hydraulic valve 11 are required for controlling speed of valve closure caused by spring 12, and are mounted in such way that the rod of the hydraulic cylinder 9 is coupled to lever 10.

The drive shown in FIG. 2 is operated as follows:

(a) The normal operation of the drive according to the second embodiment is generally similar to the respective operation of the drive according to the first embodiment. In this mode, the stop device 3 is locked. The hydraulic valve 11 is open, which allows the oil to flow freely from one chamber into the other, and allows the rod of the hydraulic cylinder 9 to move freely. The rotation is transferred from servomotor 2 via differential reducer 4 to nut 6. The rotation of nut 6 causes translational movement of screw 7, which closes or opens the steam-distributing valve by means of lever 10. Power consumption of the drive is relatively low due to the low movement speed in normal operation.

(b) When it is necessary to close the steam-distributing valve quickly (rapid changes in steam supply are only permitted with a load reduction, i.e. with reduction in steam supply, as a rapid increase in steam supply can damage turbine blades), the stop device 3 is released, thus opening of the kinematic power circuit of the drive. The return spring 12 releases accumulated energy, which provides rapid movement of lever 10 and quick closure of the steam-distributing valve. The speed of closure of the steam-distributing valve is controlled by means of hydraulic valve 11 limiting the speed of oil movement between chambers of the hydraulic cylinder 9. When it is necessary to partially close the steam-distributing valve, the hydraulic valve 11 is completely closed at a determined point, thus preventing further movement of the rod of the hydraulic cylinder 9, lever 10 coupled thereto, and the steam-distributing valve, accordingly.

The differential reducer 4 can be, for example, a planetary reducer, a cycloidal reducer, or any other type of reducer.

1. A valve drive for actuating a valve, comprising:
a main motor,
a main shaft,
a transmitting device comprising a nut and a spindle, and adapted to transform rotational movement of the nut into a translational movement of the spindle, and
wherein the main motor is adapted to transfer rotation to the nut via the main shaft, wherein the spindle is adapted to open and close the valve during the translational movement of the spindle,
a differential mechanism mounted between the main motor and the main shaft, said differential mechanism comprising a first input shaft connecting the differential mechanism to the main motor, and a second input shaft, wherein the main shaft is an output shaft of the differential mechanism, and said drive further comprises a stop device adapted to stop the second shaft, wherein
the gear ratio between the second input shaft and the main shaft is less than the gear ratio between the first input shaft and the main shaft.

2. The drive according to claim 1, wherein the main motor comprises at least one servomotor.

3. The drive according to claim 1, further comprising a rotation preventing mechanism adapted to prevent rotation of the spindle.

4. The drive according to claim 1, wherein the transmitting device is formed as a roller screw, wherein the spindle has a screw thread and transmitting rollers are provided between the nut and the spindle.

5. The drive according to claim 1, wherein the transmitting device is formed as a ball screw, wherein the spindle has a screw thread, and transmitting balls are provided between the nut and the spindle.

6. The drive according to claim 1, wherein the gear ratio between the first input shaft and the main shaft and between the second input shaft and the main shaft of the differential mechanism is represented by equation i₂=i₁/(i₁+1) or i₂=(i₁+1)/i₁, where i₁ is gear ratio between the first input shaft and the main shaft, and i₂ is gear ratio between the second input shaft and the main shaft, wherein i₁≧3.

7. The drive according to claim 1, wherein the driving means are formed by a second motor mounted on the second input shaft and adapted to transfer rotation via the differential mechanism and the main shaft to the nut in order to actuate the spindle.

8. The drive according to claim 7, wherein the second motor has greater nominal power than the main motor.

9. The drive according to claim 1, wherein the driving means are formed by a spring assembly adapted to accumulate energy when opening or closing the valve and adapted to release the accumulated energy when the stop device is released, in order to quickly close or open the valve.

10. The drive according to claim 9, wherein the spring assembly is mounted on the second input shaft and adapted to transfer rotation from said shaft via the differential mechanism and the main shaft to the nut in order to actuate the spindle.

11. The drive according to claim 9, wherein the transmitting device is further adapted to transform translational movement of the spindle into rotational movement of the nut.

12. The drive according to claim 11, wherein the spring assembly comprises a return spring connected to the spindle.

13. The drive according to claim 11, wherein the spindle is connected to the valve with a lever, and the spring assembly comprises a return spring connected to said lever.

14. The drive according to claim 10, wherein the driving means comprise at least one two-chamber hydraulic cylinder and a hydraulic control valve for controlling the hydraulic cylinder, wherein the rod of said at least one hydraulic cylinder is coupled to the valve, wherein the hydraulic control valve is adapted to control speed of the valve closure and/or opening.

15. The drive according to claim 14, wherein the hydraulic control valve is adapted to restrain valve movement.

16. The drive according to claim 1, wherein the stop device is formed by a self-locking worm gear adapted to disengage gears thereof.

17. The drive according to claim 1, wherein the valve is a steam-distributing valve.

18. The drive according to claim 1, wherein the gear ratio between the second input shaft and the main shaft is about 1:1.

19. A valve drive for actuating a valve comprising:
a main motor,
a main shaft,
a transmitting device comprising a nut and a spindle and adapted to transform rotational movement of the nut into a translational movement of the spindle, and
a second motor having greater nominal power than the main motor, wherein the main motor is adapted to transfer rotation to the nut via the main shaft, wherein the spindle is adapted to open and close the valve during the translational movement of the spindle,
a differential mechanism mounted between the main motor and the main shaft, said differential mechanism comprising a first input shaft connecting the differential mechanism to the main motor, and a second input shaft, wherein the main shaft is an output shaft of the differential mechanism, and said drive further comprises a stop device adapted to stop the second shaft, wherein
the second motor is mounted on the second input shaft and adapted to transfer rotation via the differential mechanism and the main shaft to the nut in order to actuate the spindle,
and wherein the gear ratio between the second input shaft and the main shaft is less than the gear ratio between the first input shaft and the main shaft.

20. A valve drive for actuating a valve comprising:
a main motor,
a main shaft,
a transmitting device comprising a nut and a spindle and adapted to transform rotational movement of the nut into a translational movement of the spindle, and
a spring assembly,
wherein the main motor is adapted to transfer rotation to the nut via the main shaft, wherein the spindle is adapted to open and close the valve during the translational movement of the spindle,
a differential mechanism mounted between the main motor and the main shaft, said differential mechanism comprising a first input shaft connecting the differential mechanism to the main motor, and a second input shaft, wherein the main shaft is an output shaft of the differential mechanism, and said drive further comprises a stop device adapted to stop the second shaft, wherein
the spring assembly is adapted to accumulate energy when opening or closing the valve and adapted to release the accumulated energy when the stop device is released, in order to quickly close or open the valve,
and wherein the gear ratio between the second input shaft and the main shaft is less than the gear ratio between the first input shaft and the main shaft.
